(19) United States
(12) Patent Application Publication
(10) Pub. No.: US 2021/0304127 A1
(43) Pub. Date: Sep. 30, 2021

(54) UNMANNED DELIVERY MACHINE

(71) Applicant: HONDA MOTOR CO., LTD., Tokyo (JP)

(72) Inventors: Kensaku Yamamoto, Wako-shi (JP); Koichi Ogura, Tokyo (JP); Ryohei Iwaki, Wako-shi (JP)

(21) Appl. No.: 17/194,334

(22) Filed: Mar. 8, 2021

(30) Foreign Application Priority Data
Mar. 31, 2020 (JP) 2020-063773

(51) Int. Cl. G06Q 10/08; G06Q 30/02; G09F 21/04; B60R 11/00; G01G 19/08

(52) U.S. Cl. CPC G06Q 10/0832; G06Q 30/0265; B60R 2011/0036; B60R 11/00; G01G 19/08; G09F 21/048

(57) ABSTRACT

An unmanned delivery machine capable of improving convenience is provided. An unmanned delivery machine includes a vehicle body, a drive device, a baggage storage part, and doors. The drive device is configured to automatically drive the vehicle body. The baggage storage part is provided on the vehicle body. Doors are provided on a front surface and a rear surface of the vehicle body, are configured to allow access to the baggage storage part and are openable and closable.

### CROSS-REFERENCE TO RELATED APPLICATION

Priority is claimed on Japanese Patent Application No. 2020-063773, filed Mar. 31, 2020, the content of which is incorporated herein by reference.

### BACKGROUND OF THE INVENTION

### Field of the Invention

The present invention relates to an unmanned delivery machine.

### Description of Related Art

An unmanned delivery system that delivers baggage using an autonomous mobile device is known (Patent Document 1 (Japanese Unexamined Patent Application, First Publication No. 2018-058656)).

In the aforementioned related art, baggage is put in and taken out from a side surface of the autonomous mobile device, which may not be convenient for users.

The present invention has been made in consideration of such circumstances, and one object of the present invention is to provide an unmanned delivery machine capable of improving convenience.

### SUMMARY OF THE INVENTION

The unmanned delivery machine according to the present invention has the following configuration.

(1) The unmanned delivery machine according to an aspect of the present invention includes a vehicle body, a drive device which is configured to automatically drive the vehicle body, a baggage storage part provided on the vehicle body, and doors which are provided on a front surface and a rear surface of the vehicle body, are configured to allow access to the baggage storage part and are openable and closable.

(2) In the unmanned delivery machine according to the aspect (1), the baggage storage part may include a front storage part and a rear storage part which are partitioned from each other, and the doors may include a front door which is provided on the front surface of the vehicle body and is configured to allow access to the front storage part and is openable and closable and a rear door which is provided on the rear surface of the vehicle body and is configured to allow access to the rear storage part and is openable and closable.

(3) The unmanned delivery machine according to the aspect (1) or (2) may further include a display part which is configured to display a delivery status on the front surface or the rear surface of the vehicle body.

(4) In the unmanned delivery machine according to the aspect (3), the display part may display at least a part of the delivery status on the surface of the door.

(5) In the unmanned delivery machine according to the aspect (3) or (4), the display part may be a projector, a liquid crystal display or an organic electroluminescence display.

(6) The unmanned delivery machine according to any one of aspects (1) to (5) may further include a restricting fixture that is visible from the outside when the vehicle is stopped and is configured to restrict movement of the vehicle body.

(7) In the unmanned delivery machine according to the aspect (6), the restricting fixture may be a brake.

(8) In the unmanned delivery machine according to any one of aspects (1) to (7), the baggage storage part may include an upper storage part and a lower storage part which are arranged above and below each other, the doors may include an upper door which is configured to allow access to the upper storage part and is openable and closable and a lower door which is configured to allow access to the lower storage part and is openable and closable, and the lower storage part may have a slider which is movable between a first position at which it is accommodated in the lower storage part and a second position at which it protrudes from the vehicle body.

(9) The unmanned delivery machine according to any one of aspects (1) to (8) may further include a display part which is provided on a side surface of the vehicle body and is capable of displaying advertisements.

(10) In the unmanned delivery machine according to any one of aspects (1) to (9), the baggage storage part may include a first storage part and a second storage part which are aligned with each other, the doors may include a first door which is configured to allow access to the first storage part and is openable and closable and a second door which is configured to allow access to the second storage part and is openable and closable, the first door and the second door may be arranged to be adjacent to each other, an end portion of the first door on an opposite side of the second door may be supported by a first hinge, and an end portion of the second door on an opposite side of the first door may be supported by a second hinge.

(11) In the unmanned delivery machine according to the aspect (10), the baggage storage part may have a partition between the first storage part and the second storage part, and the partition may be detachable.

(12) In the unmanned delivery machine according to the aspect (10) or (11), each of the first door and the second door may be openable up to 90 degrees.

(13) The unmanned delivery machine according to any one of aspects (1) to (12) may further include a weight detection part capable of measuring a weight of baggage placed on the upper surface of the vehicle body.

According to the aspects (1) to (13), convenience can be improved.

### BRIEF DESCRIPTION OF THE DRAWINGS

FIG. 1 is a configuration diagram of a transportation system 1 including a baggage transportation vehicle 200.

FIG. 2 is a configuration diagram of a management device 300.

FIG. 3 is a diagram conceptually showing content of transfer schedule information 396.

FIG. 4 is a perspective view of the baggage transportation vehicle 200.

FIG. 5 is a diagram showing a functional configuration of the baggage transportation vehicle 200.

FIG. 6 is a diagram showing an appearance of the baggage transportation vehicle 200.

FIG. 7 is a perspective view showing a slider 281.

FIG. 8 is a perspective view showing a restricting fixture 291.

FIG. 9 is a diagram for explaining the operation of the baggage transportation vehicle 200.

FIG. 10 is a perspective view of a baggage transportation vehicle 200A of a second embodiment.

FIG. 11 is a perspective view of a baggage transportation vehicle 200B of a third embodiment.

FIG. 12 is a plan view of a front end portion of the baggage transportation vehicle 200B of the third embodiment.

FIG. 13 is a perspective view of a baggage transportation vehicle 200C of a fourth embodiment.

### DETAILED DESCRIPTION OF THE INVENTION

Hereinafter, embodiments of an unmanned delivery machine of the present invention will be described with reference to the drawings. In the following description, configurations having the same or similar functions are designated by the same reference numerals. Further, in some cases, repeated description of those configurations may be omitted.

The unmanned delivery machine is used in a transportation system that includes a management device. The unmanned delivery machine can autonomously drive on a road without a driver on board, and has a baggage storage part shielded by an openable door. Front, back, left, and right referred to in the present specification are defined on the basis of a main traveling direction of the unmanned delivery machine.

The unmanned delivery machine recognizes an external situation through monitoring units such as a camera, a radar device, and a light detection and ranging (LIDAR). In general, the unmanned delivery machine moves on the road while avoiding obstacles on the road, and travels along a route instructed by the management device. In the unmanned delivery machine, wheels are driven by, for example, a motor and move on the road at a speed of about 10 [km]. The baggage storage part of the unmanned delivery machine has, for example, a plurality of baggage loading spaces partitioned from each other, and a plurality of users can load (carry in) each piece of baggage.

The management device manages (controls) the operation of the unmanned delivery machine. The management device may be a device which is placed in a different place from the unmanned delivery machine and may communicate with the unmanned delivery machine via a network. The management device may have some or all functions installed in the unmanned delivery machine. The management device generates transportation schedule information, for example, on the basis of application information acquired from a user's terminal device by communication. Further, the management device instructs the unmanned delivery machine about a route or a stop location of the unmanned delivery machine, opening and closing of the door of the baggage storage part, and the like, on the basis of the transportation schedule information.

In the following explanation, the management device is a device placed in a different location from the unmanned delivery machine (for example, a device in a form called a cloud server). The management device realizes the aforementioned function by communicating with the user's terminal device or the unmanned delivery machine via the network.

### First Embodiment

### 1. Overall Configuration

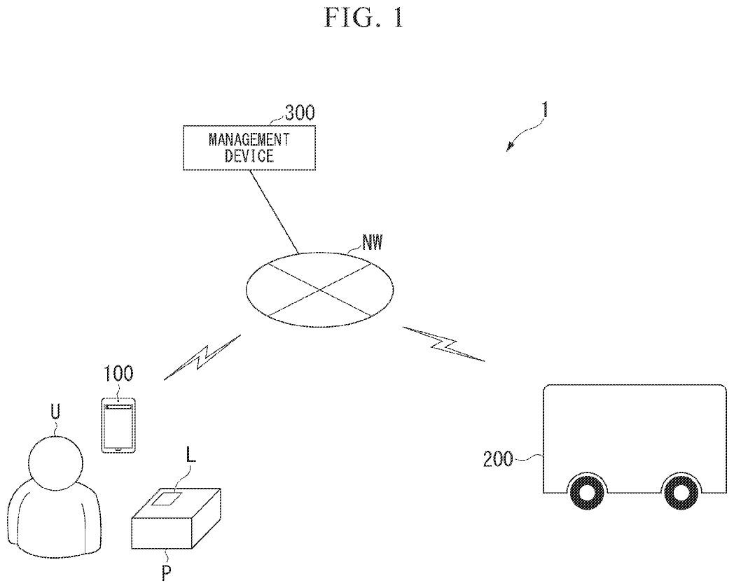

FIG. 1 is a configuration diagram of a transportation system 1 which includes a baggage transportation vehicle (an unmanned delivery vehicle) 200, which is an example of an unmanned delivery machine, and a management device 300. The transportation system 1 includes one or more baggage transport vehicles 200 and a management device 300. The management device 300 communicates with a terminal device 100 used by a user U via a network NW. The network NW includes the Internet, a wide area network (WAN), a local area network (LAN), a public line, a provider device, a dedicated line, a wireless base station or the like. The management device 300 communicates with the baggage transportation vehicle 200 via the network NW. The term “terminal device used by the user” may include a terminal device that can be used by an unspecified number of people, such as a terminal device of an Internet cafe, which is temporarily used by the user. In any case, “user's terminal device” refers to a terminal device of which the user performing operation is specified by, for example, a login operation in which a login name is input.

The user U transmits the application information for requesting the transportation of the baggage P to the management device 300 using the terminal device 100. A label L, in which identification information of the baggage P and/or the user U is described or a built-in IC tag or the like is stored, is assigned to the baggage P.

The terminal device 100 is, for example, a smartphone, a tablet terminal, a personal computer, or the like. In the terminal device 100, an application program for using the service, a browser, or the like is started to support services to be described below. In the following description, it is assumed that the terminal device 100 is a smartphone and an application program (transportation service application) for receiving the service is started. The transportation service application communicates with the management device 300 according to the operation of the user U, sends the application information from the user U to the management device 300, or provides information based on the information received from the management device 300. The application information is electronic information that requires the baggage transportation vehicle 200 to transport the baggage P over a designated section.

Hereinafter, for convenience of explanation, the details of the baggage transportation vehicle 200 and the management device 300 will be described in the order of the management device 300 and the baggage transportation vehicle 200.

### 2. Management Device

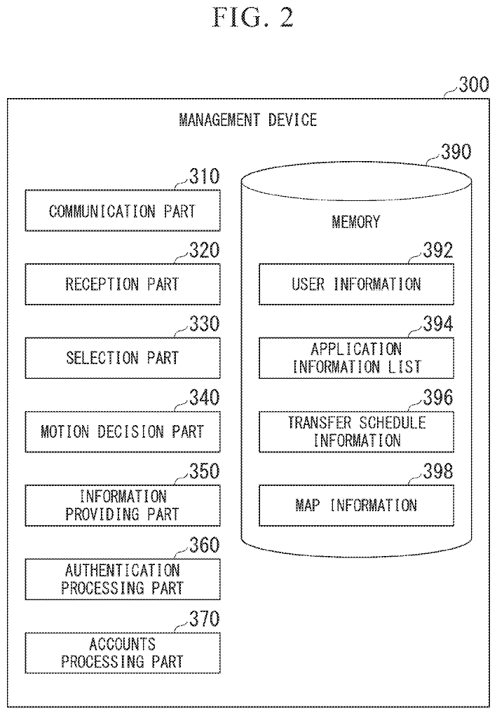

FIG. 2 is a configuration diagram of the management device 300. The management device 300 is equipped with, for example, a communication part 310, a reception part 320, a selection part 330, an motion decision part 340, an information providing part 350, an authentication processing part 360, and an account processing part 370. These components are realized by, for example, a hardware processor such as a central processing unit (CPU) executing a program (software). Some or all of these components may be realized by hardware (a circuit part including circuitry) such as a large scale integration (LSI), an application specific integrated circuit (ASIC), a field-programmable gate array (FPGA), and a graphics processing unit (GPU). The components of the management device 300 may be realized by software and hardware in cooperation. The program may be stored in advance in a storage device (a storage device including a non-transient storage medium) such as a hard disk drive (HDD) or a flash memory. The program may be stored in a detachable storage medium (non-transient storage medium) such as a DVD or a CD-ROM, and may be installed in the storage device by mounting the storage medium in the drive device.

The management device 300 may include a storage part 390. The storage part 390 is realized by a DVD, a random access memory (RAM), a flash memory, or the like. Information such as user information 392, application information list 394, transfer schedule information 396, and map information 398 is stored in the storage part 390.

As the user information 392, for example, information such as communication identification information, a name, a sex, an age, an address, and an occupation are associated with the user ID, which is the identification information of the user U. As the application information list 394, information such as a loading point (a delivery source point, and a baggage collection point), an unloading point (a delivery destination point), a desired delivery time, and a package type indicating the size and shape of the baggage P are registered for each piece of baggage P. The transfer schedule information 396 includes information defining the movement of each baggage transportation vehicle 200.

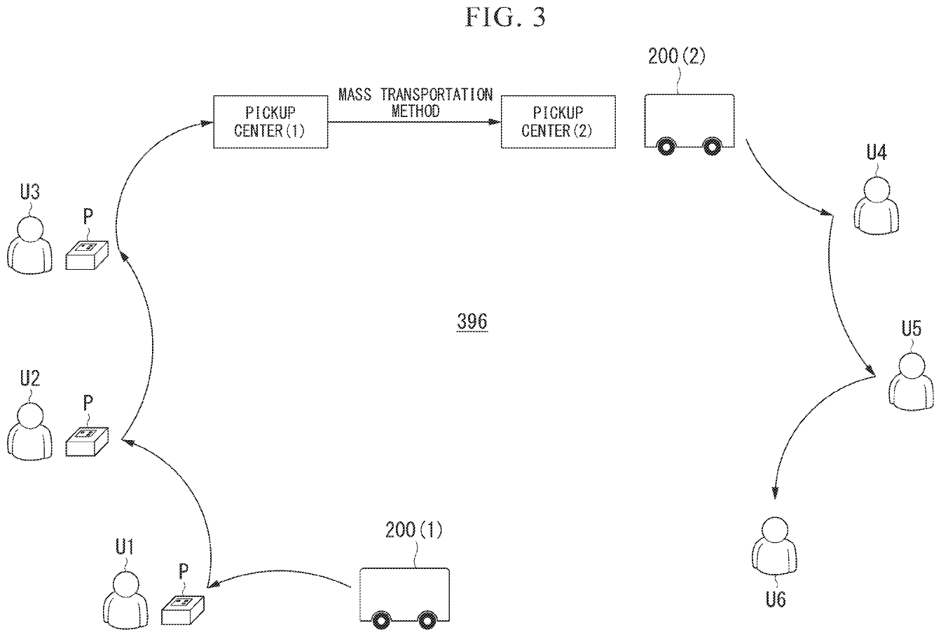

FIG. 3 is a diagram conceptually showing the content of the transfer schedule information 396. As shown in the drawing, the transfer schedule information 396 includes information that defines a series of operations in which a certain baggage transportation vehicle 200 (1) collects the baggage P of a user U1 at the loading point of the user U1 and the desired loading time, collects the baggage P of a user U2 at the loading point of the user U2 and the desired loading time, and then collects the baggage P of a user U3 at the loading point of the user U3 and the desired loading time, and transports the baggage to the collection center (1). At the collection center, work is performed so that the collected baggage P is sorted according to the region of the delivery destination and then transported to another collection center. Between the collection centers (from the collection center (1) to the collection center (2) in the drawing), the baggage P is transported by a large-scale transportation means such as a large truck or a railroad. The transfer schedule information 396 may further include information that defines an operation of delivering the baggage P from the collection center (2) in the order of the users U4, U5, and U6. Regarding delivery from the collection center, for example, by searching the application information list 394 using the label information obtained from the label L as a key, information on the delivery destination (unloading point) is acquired. The operation of the baggage transportation vehicle 200 (2) is determined on the basis of the delivery destination information.

Referring to FIG. 2, each configuration of the management device 300 will be described. The communication part 310 is, for example, a network card for connecting to a network NW. The communication part 310 communicates with the terminal device 100 and the vehicle 200 via the network NW.

The reception part 320 acquires (accepts) application information issued from the terminal device 100 of the user U via the communication part 310, and adds it to the application information list 394.

When a record of new application information is added to the application information list 394, the selection part 330 refers to the list (not shown) of baggage transportation vehicles 200 and the transfer schedule information 396, and selects the baggage transportation vehicle 200 used for the user U related to the application information among the plurality of baggage transportation vehicles 200.

The motion decision part 340 generates the transfer schedule information 396 as described above. For example, the motion decision part 340 roughly groups the records of application information for each date, time zone, and region. After that, the motion decision part 340 sets some movement patterns in which a plurality of loading points and desired loading times are arranged in order, extracts the optimum movement pattern by referring to the map information 398, and adds the optimum movement pattern to the transfer schedule information 396. Further, the motion decision part 340 transmits a motion instruction to the baggage transportation vehicle 200 using the communication part 310 according to the content described in the transfer schedule information 396.

The information providing part 350 provides the position information of the baggage transportation vehicle 200 to the terminal device 100 of the user U. The information providing part 350 transmits the position information uploaded by the communication control part 271 of the baggage transportation vehicle 200 using the communication device 214 to the terminal device 100 using the communication part 310.

The authentication processing part 360 acquires, for example, various types of information (a password, biological information, a token, and the like) acquired by the authentication device 253 (to be described below) of the baggage transportation vehicle 200. When the acquired information is valid, the authentication processing part 360 notifies the motion decision part 340 that the information was successfully authenticated. In response to this, the motion decision part 340 transmits information instructing the baggage transportation vehicle 200 to open one of the doors 220 (to be described below).

The account processing part 370 performs processing for collecting charges from the user U. For example, the account processing part 370 cooperates with a credit card or electronic money management server to collect a fee from the user U.

### 3. Baggage Transportation Vehicle

### 3.1 Summary of Baggage Transportation Vehicle

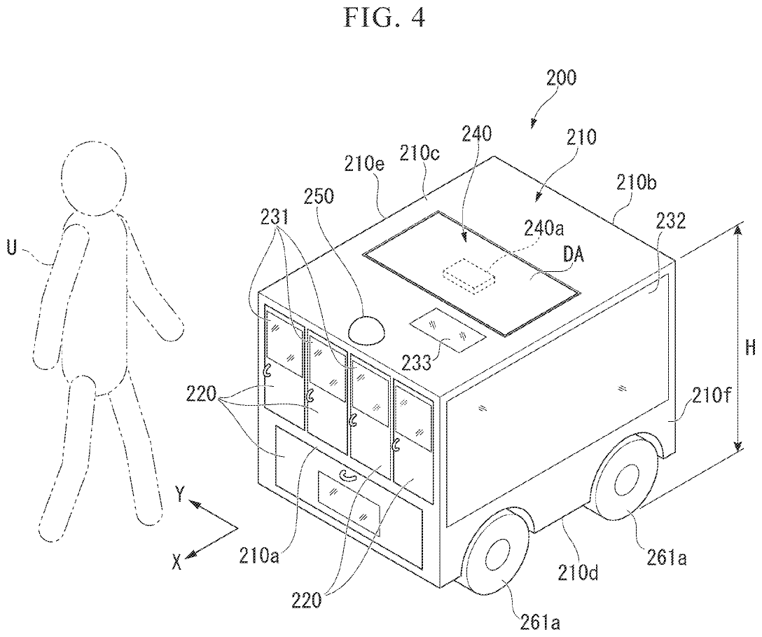

FIG. 4 is a perspective view of the baggage transportation vehicle 200. The baggage transportation vehicle 200 is, for example, a relatively small (short) vehicle, and has a height lower than an average height of the user U. For example, a height H of the baggage transportation vehicle 200 is 120 cm or less. The baggage transportation vehicle 200 includes, for example, a vehicle body 210, a plurality of doors 220, first to third display devices 231, 232 and 233, a weight detection part 240, and a monitoring unit 250.

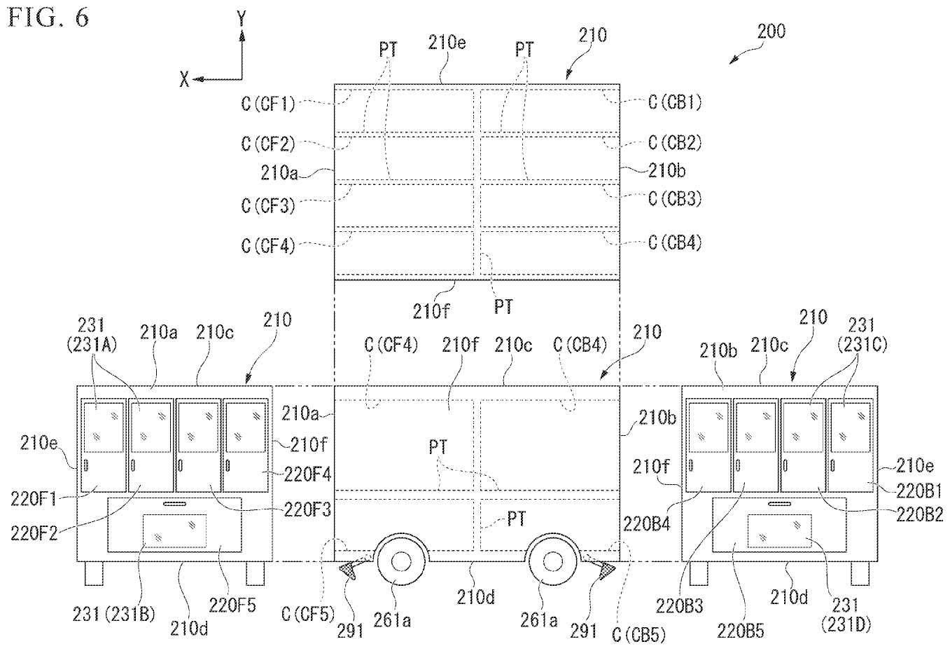

The vehicle body 210 is formed in, for example, a box shape, and has a front surface 210a, a rear surface 210b, an upper surface 210c, a lower surface 210d, a left side surface 210e, and a right side surface 210f. The vehicle body 210 is not limited to a rectangular parallelepiped shape, and may include an inclined portion or a portion formed in a curved surface shape. A baggage storage part C (see FIG. 6) capable of storing a plurality of pieces of baggage P is provided inside the vehicle body 210. The baggage storage part C will be described below.

The plurality of doors 220 are provided on the front surface 210a and the rear surface 210b of the vehicle body 210 (see FIG. 6). The first display device 231 is provided on the door 220. The second display device 232 is provided on each of the left side surface 210e and the right side surface 210f of the vehicle body 210. The third display device 233 is provided on the upper surface 210c of the vehicle body 210. Each of the first to third display devices 231, 232 and 233 is, for example, a liquid crystal display or an organic electroluminescence (organic EL) display. The weight detection part 240 is provided on the upper part of the vehicle body 210. The door 220, the display devices 231, 232 and 233, and the weight detection part 240 will be described below in detail.

The monitoring unit 250 is provided, for example, on the upper surface 210c of the vehicle body 210. The monitoring unit 250 includes a camera, a radar device, a light detection and ranging (LIDAR), and the like. The detection result of the monitoring unit 250 is output to the controller 270 (to be described below).

### 3.2 Functional Configuration of Baggage Transportation Vehicle

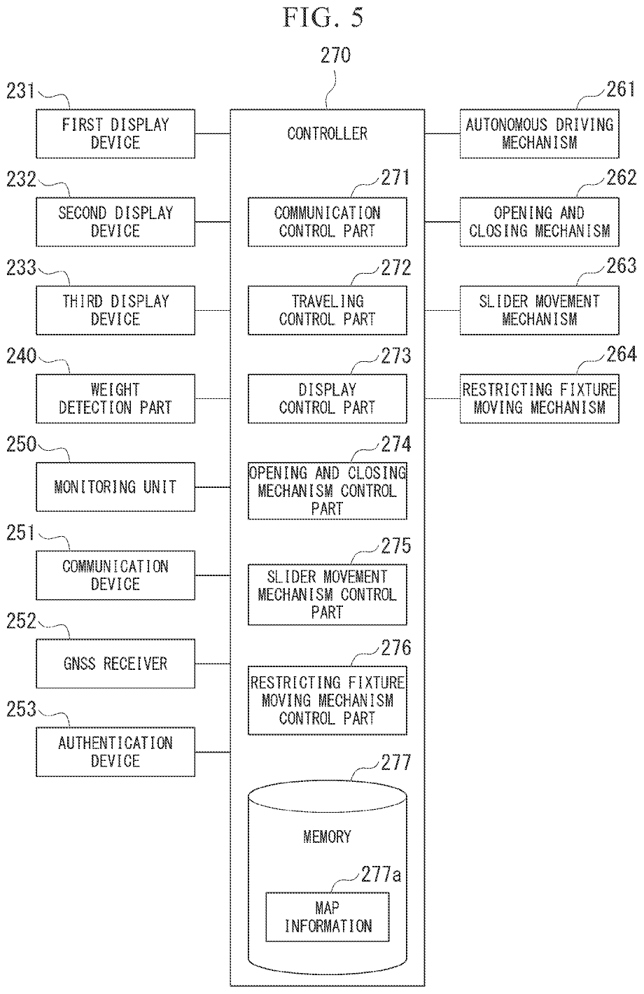

FIG. 5 is a diagram showing a functional configuration of the baggage transportation vehicle 200. In addition to the first to third display devices 231, 232 and 233, the weight detection part 240, and the monitoring unit 250 mentioned above, the baggage transportation vehicle 200 has a communication device 251, a GNSS receiver 252, an authentication device 253, an autonomous driving mechanism 261, an opening and closing mechanism 262, a slider movement mechanism 263, a restricting fixture moving mechanism 264, and a controller (control unit) 270.

The communication device 251 is, for example, a wireless communication module for connecting to a network NW or directly communicating with a terminal device of another vehicle or a pedestrian. The communication device 251 performs wireless communication on the basis of Wi-Fi, dedicated short range communications (DSRC), Bluetooth (registered trademark), or another communication standard. As the communication device 251, a plurality of communication devices 251 may be prepared according to the application.

The GNSS receiver 252 positions its own position (a position of the baggage transportation vehicle 200) on the basis of radio waves arriving from a GNSS satellite (for example, a GPS satellite). The GNSS receiver 252 outputs the positioning result to the controller 270.

The authentication device 253 is a device for checking that the user U who intends to load the baggage P into the baggage transportation vehicle 200 is a legitimate user (authenticates the user). A legitimate user refers to a user who has made an agreement (reservation) regarding the transportation of baggage with the management device 300. The authentication device 253 may be any device as long as it has an authentication function, such as a short-range wireless communication device, a biometric authentication device, and a password input device. The authentication device 253 outputs the authentication result to the controller 270. For example, the authentication device 253 may be provided integrally with the first display device 231.

The autonomous driving mechanism 261 includes a plurality of wheels 261a (see FIG. 4), a driving force source such as a motor, an energy storage means such as a battery, a steering mechanism, and the like. The autonomous driving mechanism 261 automatically drives the baggage transportation vehicle 200 in an arbitrary direction according to an instruction from the controller 270 of the baggage transportation vehicle 200. The autonomous driving mechanism 261 is an example of a “driving device”.

The opening and closing mechanism 262 is provided for each of the plurality of doors 220. The opening and closing mechanism 262 includes a motor, an arm, and the like. The opening and closing mechanism 262 opens/closes the doors 220 individually. The opening and closing mechanism 262 is equipped with, for example, a switch for detecting that the door 220 is manually closed.

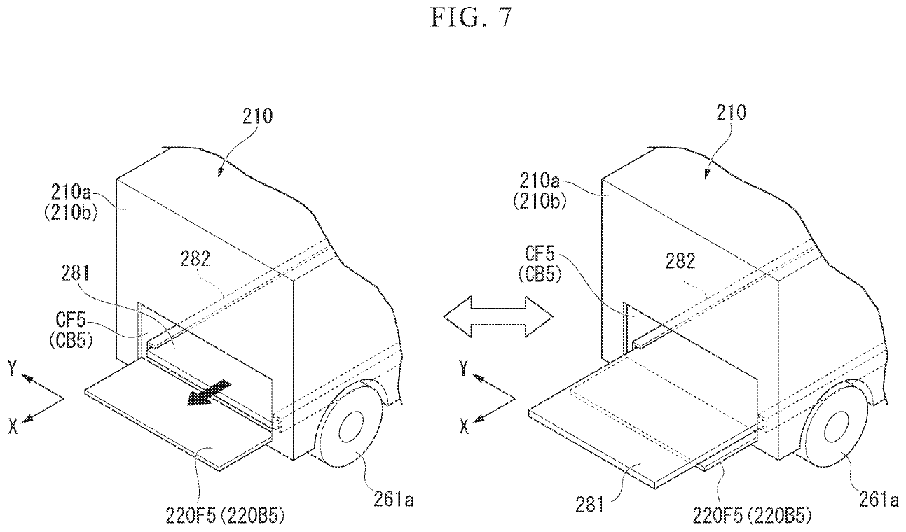

The slider movement mechanism 263 is a mechanism which moves a slider 281 (see FIG. 7), which will be described below. The slider 281 is provided in each of a lower front storage part CF5 and a lower rear storage part CB5, which will be described below. The slider 281 is a member that assists the storage of the baggage P (for example, a heavy baggage P) to the baggage storage part C. The slider 281 will be described below in detail.

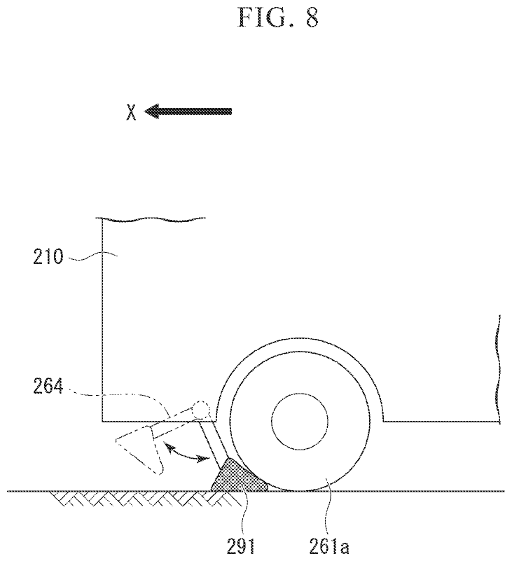

The restricting fixture moving mechanism 264 is a mechanism that moves a restricting fixture 291 (see FIG. 8), which will be described below. The restricting fixture 291 is provided, for example, on the vehicle body 210. The restricting fixture 291 is a member that restricts the movement of the vehicle body 210 when the vehicle is stopped. The restricting fixture 291 will be described below in detail.

The controller 270 includes, for example, a communication control part 271, a traveling control part 272, a display control part 273, an opening and closing mechanism control part 274, a slider movement mechanism control part 275, and a restricting fixture moving mechanism control part 276. These components are realized, for example, by a hardware processor such as a CPU executing a program (software). Some or all of the components may be realized by hardware (a circuit unit including circuitry) such as an LSI, an ASIC, an FPGA, and a GPU. The components of the controller 270 may be realized by the collaboration of software and hardware. The program may be stored in advance in a storage device such as an HDD or a flash memory (a storage device equipped with a non-transient storage medium). The program may be stored in a detachable storage medium (non-transient storage medium) such as a DVD or a CD-ROM, or may be installed in the storage device by mounting the storage medium in the drive device. The controller 270 has a memory 277 that stores the map information 277a. The memory 277 is an HDD, a flash memory, a ROM, a random access memory (RAM), or the like.

The communication control part 271 acquires route information from the management device 300 via the communication device 251, and outputs the route information to the traveling control part 272. The communication control part 271 uploads the position information indicating the position determined by the GNSS receiver 252 to the management device 300, using the communication device 251. The position information is uploaded periodically, for example, in milliseconds to seconds.

The traveling control part 272 controls the autonomous driving mechanism 261 so that the baggage transportation vehicle 200 drives on the route designated by the management device 300. For example, the traveling control part 272 matches the route acquired from the management device 300 with the map information 277a and the output of the monitoring unit 250, and determines a detailed route on which the baggage transportation vehicle 200 needs to travel. The traveling control part 272 autonomously drives the baggage transportation vehicle 200 to avoid contact with an object (including a guardrail, a curb, and the like) whose position and speed are input from the monitoring unit 250, while principally traveling on the route.

The traveling control part 272 stops the baggage transportation vehicle 200 when receiving a stop instruction from the management device 300. Instead of this, in a case where the route information includes the stop position information, the traveling control part 272 may stop the baggage transportation vehicle 200 when the positioning result of the GNSS receiver 252 and the stop position match. That is, the management device 300 gives a stop instruction or information on the stop position to the traveling control part 272, and the traveling control part 272 stops the baggage transportation vehicle 200 accordingly. The position at which the baggage transportation vehicle 200 is stopped includes a road surface. In particular, when the user U loads the baggage P into the baggage storage part C of the baggage transportation vehicle 200, the baggage transportation vehicle 200 stops on the road or in a parking lot.

The display control part 273 controls a video (or images) displayed on the first to third display devices 231, 232, and 233. The contents displayed on the first to third display devices 231, 232, and 233 will be described below.

The opening and closing mechanism control part 274 drives the opening and closing mechanism 262 at the timing instructed by the management device 300. As a result, the opening and closing mechanism control part 274 automatically opens the door 220, and the baggage storage part C is opened to the outside of the vehicle body 210.

The slider movement mechanism control part 275 drives the slider movement mechanism 263 at the timing when the lower front door 220F5 (to be described below) is opened. The slider movement mechanism control part 275 moves the slider 281 accommodated in the lower front storage part CF5 and causes the slider 281 to protrude to the outside of the vehicle body 210. After the baggage P is placed on the slider 281, the slider movement mechanism control part 275 drives the slider movement mechanism 263 to return the slider 281 to the inside of the lower front storage part CF5. Similarly, the slider movement mechanism control part 275 drives the slider movement mechanism 263 at the timing when the lower rear door 220B5 (to be described below) is opened. The slider movement mechanism control part 275 moves the slider 281 accommodated in the lower rear storage part CB5 and causes the slider 281 to protrude to the outside of the vehicle body 210. After the baggage P is placed on the slider 281, the slider movement mechanism control part 275 drives the slider movement mechanism 263 to return the slider 281 to the inside of the lower rear storage part CB5.

The restricting fixture moving mechanism control part 276 drives the restricting fixture moving mechanism 264 when the baggage transportation vehicle 200 is stopped, and moves the restricting fixture 291 to a position at which the movement of the baggage transportation vehicle 200 is restricted. The restricting fixture moving mechanism control part 276 drives the restricting fixture moving mechanism 264 at the time of departure of the baggage transportation vehicle 200, and moves the restricting fixture 291 to a position at which the movement of the baggage transportation vehicle 200 is not restricted.

### 3.3 Hardware Configuration of Baggage Transportation Vehicle

Next, the details of the hardware configuration of the baggage transportation vehicle 200 will be described.

### 3.3.1 Arrangement of Baggage Storage Part and Door

FIG. 6 is a diagram showing the appearance of the baggage transportation vehicle 200. In the present embodiment, the baggage storage part C includes upper front storage parts CF1, CF2, CF3 and CF4, upper rear storage parts CB1, CB2, CB3 and CB4, a lower front storage part CF5, and a lower rear storage part CB5.

The upper front storage parts CF1, CF2, CF3, and CF4 are arranged with each other in a vehicle width direction Y. Each of the upper front storage parts CF1, CF2, CF3, and CF4 has an internal space (accommodation part) in which the baggage P can be stored, and an opening that opens toward the front of the vehicle body 210. The upper front storage parts CF1, CF2, CF3, and CF4 are partitioned from each other by a partition PT. The upper front storage part CF1 is an example of the “first storage part”. The upper front storage part CF2 is an example of the “second storage part”.

The upper rear storage parts CB1, CB2, CB3, and CB4 are provided behind the upper front storage parts CF1, CF2, CF3, and CF4. In other words, the upper front storage parts CF1, CF2, CF3 and CF4 and the upper rear storage parts CB1, CB2, CB3, CB4 are arranged in a front-rear direction (a vehicle traveling direction X). The upper rear storage parts CB1, CB2, CB3, and CB4 are arranged with each other in the vehicle width direction Y. Each of the upper rear storage parts CB1, CB2, CB3, and CB4 has an internal space (accommodation part) in which the baggage P can be stored, and an opening that opens toward the rear of the vehicle body 210. The upper rear storage parts CB1, CB2, CB3, and CB4 are partitioned from each other by a partition PT. The upper rear storage parts CB1, CB2, CB3, and CB4 are partitioned from the upper front storage parts CF1, CF2, CF3, and CF4 by the partition PT. The upper rear storage part CB1 is another example of the “first storage part”. The upper rear storage part CB2 is another example of the “second storage part”.

The lower front storage part CF5 is provided below the upper front storage parts CF1, CF2, CF3 and CF4. In other words, the upper front storage parts CF1, CF2, CF3 and CF4 and the lower front storage part CF5 are arranged one above the other. The lower front storage part CF5 has an internal space (accommodation part) in which the baggage P can be stored, and an opening that opens toward the front of the vehicle body 210. The upper front storage parts CF1, CF2, CF3 and CF4 and the lower front storage part CF5 are partitioned by the partition PT. For example, the internal space of the lower front storage part CF5 is greater than the internal space of each of the upper front storage parts CF1, CF2, CF3 and CF4. An opening area of the opening of the lower front storage part CF5 is greater than an opening area of the opening of the upper front storage parts CF1, CF2, CF3 and CF4. The lower front storage part CF5 is a storage part in which a relatively large baggage P or a relatively heavy baggage P is stored.

The lower rear storage part CB5 is provided below the upper rear storage parts CB1, CB2, CB3, and CB4. In other words, the upper rear storage parts CB1, CB2, CB3 and CB4 and the lower rear storage part CB5 are arranged one above the other. The lower rear storage part CB5 has an internal space (accommodation part) in which the baggage P can be stored, and an opening that opens toward the rear of the vehicle body 210. The upper rear storage parts CB1, CB2, CB3 and CB4 and the lower rear storage part CB5 are partitioned by the partition PT. The lower front storage part CF5 and the lower rear storage part CB5 are partitioned by the partition PT. For example, the internal space of the lower rear storage part CB5 is greater than the internal space of each of the upper rear storage parts CB1, CB2, CB3, and CB4. The opening area of the opening of the lower rear storage part CB5 is greater than the opening area of the opening of the upper rear storage parts CB1, CB2, CB3 and CB4. The lower rear storage part CB5 is a storage part in which a relatively large baggage P or a relatively heavy baggage P is stored.

In the present embodiment, the plurality of doors 220 include upper front doors 220F1, 220F2, 220F3 and 220F4, upper rear doors 220B1, 220B2, 220B3 and 220B4, a lower front door 220F5, and a lower rear door 220B5. These doors 220 are pivotally supported by, for example, a hinge (not shown) and can be opened up to, for example, 90 degrees with respect to the closing position for closing the opening of the baggage storage part C. In other words, the opening and closing mechanism 262 may have a stopper that restricts the door 220 from opening more than 90 degrees with respect to the closed position.

The upper front doors 220F1, 220F2, 220F3 and 220F4 are provided on the front surface 210a of the vehicle body 210. The upper front doors 220F1, 220F2, 220F3 and 220F4 are provided on a one-to-one basis with respect to the openings of the upper front storage parts CF1, CF2, CF3 and CF4. The upper front doors 220F1, 220F2, 220F3 and 220F4 close the upper front storage parts CF1, CF2, CF3 and CF4 to be openable and closable from the front, respectively. The lower front door 220F5 is provided on the front surface 210a of the vehicle body 210. The lower front door 220F5 is provided with respect to the opening of the lower front storage part CF5, and allows access to the lower front storage part CF5 and is openable and closable from the front.

The upper rear doors 220B1, 220B2, 220B3 and 220B4 are provided on the rear surface 210b of the vehicle body 210. The upper rear doors 220B1, 220B2, 220B3 and 220B4 are provided on a one-to-one basis with respect to the openings of the upper rear storage parts CB1, CB2, CB3, and CB4. The upper rear doors 220B1, 220B2, 220B3 and 220B4 allow access to the upper rear storage parts CB1, CB2, CB3, and CB4 and are openable and closable from the rear, respectively. The lower rear door 220B5 is provided on the rear surface 210b of the vehicle body 210. The lower rear door 220B5 is provided with respect to the opening of the lower rear storage part CB5, allows access to the lower rear storage part CB5 and is openable and closable from the rear.

### 3.3.2 First Display Device

The plurality of first display devices 231 are display parts that display various types of information including the delivery status on the front surface 210a and the rear surface 210b of the vehicle body 210. The plurality of first display devices 231 include a plurality of front display devices 231A, a front display device 231B, a plurality of rear display devices 231C, and a rear display device 231D. The plurality of front display devices 231A are provided on the front surfaces of the plurality of upper front doors 220F1, 220F2, 220F3 and 220F4, respectively. The front display device 231B is provided on the front surface of the lower front door 220F5. The plurality of rear display devices 231C are provided on the rear surfaces of the plurality of upper rear doors 220B1, 220B2, 220B3 and 220B4. The rear display device 231D is provided on the rear surface of the lower rear door 220B5. As a result, the first display device 231 displays at least a part of the delivery statuses on the surfaces of the upper front doors 220F1, 220F2, 220F3 and 220F4, the lower front door 220F5, the upper rear doors 220B1, 220B2, 220B3 and 220B4, and the lower rear door 220B5.

The plurality of front display devices 231A can display different types of information for each front display device 231A, by being controlled independently of each other. Further, the plurality of front display devices 231A can display a piece of information on the plurality of front display devices 231A (can use the plurality of front display devices 231A as a single large display device), by being controlled in cooperation with each other. For example, the plurality of front display devices 231A are controlled in cooperation with each other while the baggage transportation vehicle 200 is moving (also including the stoppage time during movement), and are used as a single large display device. At this time, the plurality of front display devices 231A displays the information which notifies the surrounding traffic participants (vehicles and/or pedestrians) of the status of the baggage transportation vehicle 200, such as “delivery of baggage”, “traveling”, and “stoppage”.

On the other hand, the plurality of front display devices 231A and 231B are independently controlled at the time of loading and unloading the baggage transportation vehicle 200. At this time, the plurality of front display devices 231A and 231B display information indicating the usage status (“usage”, “vacant”, “reserved”, and the like) of the upper front storage parts CF1, CF2, CF3 and CF4/the lower front storage part CF5 to which each of the front display devices 231A and 231B corresponds. Each of the information indicating the status of the baggage transportation vehicle 200 and the information indicating the usage status of the baggage storage part C is an example of the “delivery status”. The same also applies to the rear display devices 231C and 231D. The first display device 231 may have a touch panel function, or may have an embedded function of communicating with a non-contact type IC card.

Next, referring to FIG. 4, the second display device 232, the third display device 233, and the weight detection part 240 will be described.

### 3.3.3 Second Display Device

The second display device 232 is provided on each of the left side surface 210e and the right side surface 210f of the vehicle body 210. The second display device 232 is a display part capable of displaying an advertisement by a video or an image. The second display device 232 may be a display device greater than, for example, the first display device 231, and may occupy an area of half or more of each of the left side surface 210e and the right side surface 210f.

### 3.3.4 Third Display Device

The third display device 233 is provided on, for example, the upper surface 210c of the vehicle body 210. The weight of the baggage P detected by the weight detection part 240 is displayed on the third display device 233. In this embodiment, the delivery charge of the baggage P calculated on the basis of the detected weight of the baggage P is displayed on the third display device 233.

### 3.3.5 Weight Detection Part

The weight detection part 240 can measure the weight of the baggage P. In the present embodiment, the weight detection part 240 can detect the weight of the baggage P placed on the upper surface 210c of the vehicle body 210. For example, a weight detection area (a weighing area) DA is set on the upper surface 210c of the vehicle body 210. For example, the weight detection area DA is formed by another member with respect to other parts of the upper surface 210c of the vehicle body 210 to be movable up and down with respect to other parts of the upper surface 210c of the vehicle body 210 (to be sinkable by the weight of the baggage P). The weight detection part 240 includes, for example, one or more weight sensors 240a provided below the weight detection area DA. The weight detection part 240 detects the weight of the baggage P placed on the weight detection area DA, and causes the third display device 233 to display the weight of the detected baggage P and the confirmed delivery charge of the baggage P.

However, the configuration of the weight detection part 240 is not limited to the aforementioned example. The weight detection part 240 does not have a specially set weight detection area DA, and may have a weight sensor 240a in, for example, a suspension or the like that supports the wheels 261a of the vehicle body 210. In this case, the weight detection part 240 may detect the weight of the baggage P placed on the upper surface 210c of the vehicle body 210, on the basis of the difference between a value detected by the weight sensor 240a before the baggage P is placed and a value detected by the weight sensor 240a after the baggage P is placed.

### Slider

FIG. 7 is a perspective view showing the slider 281. The slider 281 is provided in each of the lower front storage part CF5 and the lower rear storage part CB5. For example, the slider 281 is supported by a guide rail 282 provided in the vehicle body 210 to be slidable along the vehicle traveling direction X. For example, the slider 281 provided in the lower front storage part CF5 is movable between a first position accommodated in the lower front storage part CF5 and a second position protruding to the outside of the vehicle body 210 (the front of the vehicle body 210), by the slider movement mechanism 263. The slider 281 provided in the lower rear storage part CB5 is movable between the first position accommodated in the lower rear storage part CB5 and the second position protruding to the outside of the vehicle body 210 (the rear of the vehicle body 210), by the slider movement mechanism 263. The slider 281 may be formed of one plate-shaped member or may be formed by a plurality of plate-shaped members. The user U places the baggage P on the slider 281 in a state in which the slider 281 protrudes to the outside of the vehicle body 210, and when the slider 281 returns to the inside of the lower front storage part CF5 or the lower rear storage part CB5, the baggage P can be automatically stored in the lower front storage part CF5 or the lower rear storage part CB5.

### 3.3.3 Restricting Fixture

FIG. 8 is a side view showing the restricting fixture 291. The restricting fixture 291 is a member that restricts the movement of the vehicle body 210 when the baggage transportation vehicle 200 is stopped (for example, when loading or unloading). The restricting fixture 291 is movable between a first position (indicated by a two-dot chain line in FIG. 8) that does not restrict the movement of the baggage transportation vehicle 200 and a second position (indicated by a solid line in FIG. 8) that restricts the movement of the baggage transportation vehicle 200, by the restricting fixture moving mechanism 264. The restricting fixture 291 at the second position restricts the movement of the vehicle body 210 in a state of being visible from the outside of the vehicle body 210. For example, the restricting fixture 291 is exposed to the outside in the state in which the stop of the baggage transportation vehicle 200 is also clearly visible from others. The restricting fixture 291 is, for example, a member that engages with the wheel 261a in the vehicle traveling direction X, for example, a brake.

### 4. Operation

As a comparative example, a baggage transportation vehicle in which a door for closing the baggage storage part C is provided on the side surface of the vehicle body 210 will be considered. In the baggage transportation vehicle, it is necessary for the user U to go around to the side of the baggage transportation vehicle and put in and take out the baggage P at the time of loading and unloading. Therefore, when the width of the road is narrow, there is a likelihood that it may interfere with the smooth movement of other traffic participants.

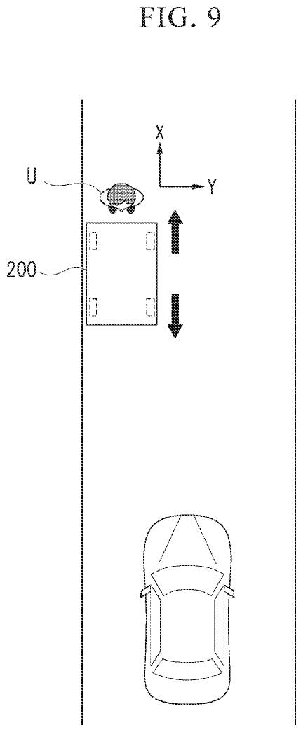

On the other hand, in the present embodiment, the baggage transportation vehicle 200 is equipped with a vehicle body 210 including the baggage storage part C and a door 220. The door 220 is provided on the front surface 210a and the rear surface 210b of the vehicle body 210, and allows access to the baggage storage part C and is openable and closable. According to such a configuration, as shown in FIG. 9, the baggage P can be put in and taken out of the baggage transportation vehicle 200 in the state in which the user U is positioned in front of or behind the baggage transportation vehicle 200. Therefore, the possibility of hindering the smooth movement of other traffic participants decreases, and the convenience of the user U can be improved.

In the present embodiment, the baggage transportation vehicle 200 has a first display device 231. The first display device 231 displays the delivery status on the front surface 210a or the rear surface 210b of the vehicle body 210. According to such a configuration, even when the door 220 is provided on the front surface 210a and the rear surface 210b of the vehicle body 210, the delivery status or the like can be notified to the outside. As a result, the convenience of the user U can be further enhanced.

In the present embodiment, the baggage transportation vehicle 200 has a restricting fixture 291. The restricting fixture 291 restricts the movement of the vehicle body 210 in the state of being visually visible from the outside when the vehicle is stopped. According to such a configuration, even when the user U is located in front of or behind the vehicle body 210 for loading and unloading the baggage P, it is possible to enhance the sense of security of the user U regarding the fact that the baggage transportation vehicle 200 does not move carelessly.

In the present embodiment, the baggage transportation vehicle 200 has a slider 281. The slider 281 is provided in the lower front storage part CF5 or the lower rear storage part CB5, and is movable between the first position accommodated in the storage part and the second position protruding to the outside of the vehicle body 210. According to such a configuration, even when the lower front storage part CF5 or the lower rear storage part CB5 is provided at a relatively low position, the user U can put in and take out the baggage P without taking a cramped posture with respect to the lower front storage part CF5 or the lower rear storage part CB5. Therefore, the convenience of the user U can be further enhanced. The lower front storage part CF5 or the lower rear storage part CB5 can be used as a storage part in which the heavy baggage P is preferentially stored to lower the center of gravity of the baggage transportation vehicle 200 when the baggage is loaded. In this case, when the slider 281 is provided, the heavy baggage P can be stored more smoothly. From this point of view, the convenience of the user U can also be further enhanced.

In the present embodiment, the door 220 can be opened up to 90 degrees from the closed position at which the baggage storage part C is closed. That is, in the present embodiment, since the door 220 is provided on the front surface 210a and the rear surface 210b of the vehicle body 210, even if the door 220 is opened widely up to 90 degrees, it does not easily interfere with other traffic participants. Therefore, the convenience of the user U can be further enhanced.

### Second Embodiment

Next, the second embodiment will be described. In the second embodiment, the arrangement of the door 220 is different from that of the first embodiment. Configurations other than that described below are the same as the configurations of the first embodiment.

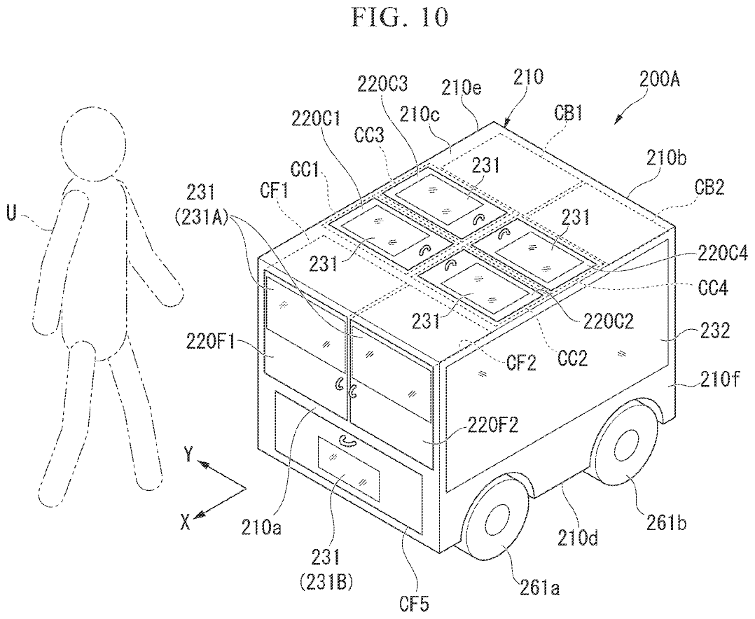

FIG. 10 is a perspective view showing a baggage transportation vehicle 200A of the second embodiment. In this embodiment, a baggage storage part C includes upper front storage parts CF1 and CF2, upper rear storage parts CB1 and CB2, upper center storage parts CC1, CC2, CC3 and CC4, a lower front storage part CF5, and a lower rear storage part CB5.

The upper front storage parts CF1 and CF2 are arranged with each other in the vehicle width direction Y. Each of the upper front storage parts CF1 and CF2 has an internal space (an accommodation part) in which the baggage P can be stored, and an opening that opens toward the front of the vehicle body 210. The upper rear storage parts CB1 and CB2 are arranged with each other in the vehicle width direction Y. Each of the upper rear storage parts CB1 and CB2 has an internal space (an accommodation part) in which the baggage P can be stored, and an opening that opens toward the rear of the vehicle body 210. Although not shown in FIG. 9 for the sake of clarity, in this embodiment, a monitoring unit 250 and a weight detection area DA are provided in a region located above the upper front storage parts CF1 and CF2 or the upper rear storage parts CB1 and CB2, on an upper surface 210c of the vehicle body 210.

The upper center storage parts CC1, CC2, CC3, and CC4 are provided between the upper front storage parts CF1 and CF2 and the upper rear storage parts CB1 and CB2 in the front-rear direction. The upper center storage parts CC1, CC2, CC3, and CC4 are arranged in the front-rear direction or the vehicle width direction Y. Each of the upper center storage parts CC1, CC2, CC3, and CC4 has an internal space (an accommodation part) in which the baggage P can be stored, and an opening that opens toward the upper part of the vehicle body 210.

In this embodiment, the plurality of doors 220 include upper front doors 220F1, 220F2, upper rear doors 220B1, 220B2, upper center doors 220C1, 220C2, 220C3 and 220C4, a lower front door 220F5, and a lower rear door 220B5. The upper center doors 220C1, 220C2, 220C3 and 220C4 are provided on the upper surface 210c of the vehicle body 210. The upper center doors 220C1, 220C2, 220C3 and 220C4 are provided on a one-to-one basis with respect to the openings of the upper center storage parts CC1, CC2, CC3, and CC4. The upper center doors 220C1, 220C2, 220C3 and 220C4 allows access to the upper center storage parts CC1, CC2, CC3, and CC4 and are openable and closable from above, respectively.

According to such a configuration, the openings of the upper front storage parts CF1 and CF2 and the openings of the upper rear storage parts CB1 and CB2 can be formed to be relatively large. The convenience of the user U regarding the loading and unloading of the baggage P can be further enhanced accordingly.

### Third Embodiment

Next, the third embodiment will be described. In the third embodiment, the arrangement of the door 220 is different from that of the second embodiment. Configurations other than those described below are the same as the configurations of the second embodiment.

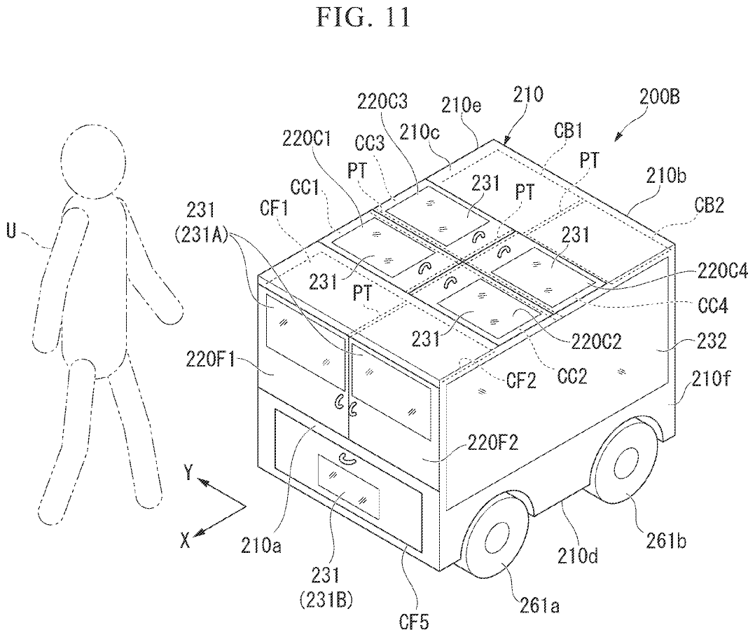

FIG. 11 is a perspective view showing a baggage transportation vehicle 200B of the third embodiment. In this embodiment, the two upper front storage parts CF1 and CF2 are provided to be adjacent to each other. The two upper front storage parts CF1 and CF2 are partitioned by a detachable partition PT. Therefore, by detaching the partition PT, the two upper front storage parts CF1 and CF2 can be used as a single large storage part.

Similarly, the two upper rear storage parts CB1 and CB2 are provided to be adjacent to each other. The two upper rear storage parts CB1 and CB2 are partitioned by the detachable partition PT. Therefore, by detaching the partition PT, the two upper rear storage parts CB1 and CB2 can be used as a single large storage part.

The four upper center storage parts CC1, CC2, CC3, and CC4 are provided to be adjacent to each other. The four upper center storage parts CC1, CC2, CC3, and CC4 are partitioned by the detachable partition PT. Therefore, by detaching a part or all of the partition PT, two or more of the four upper center storage parts CC1, CC2, CC3, and CC4 can be used as a single large storage part.

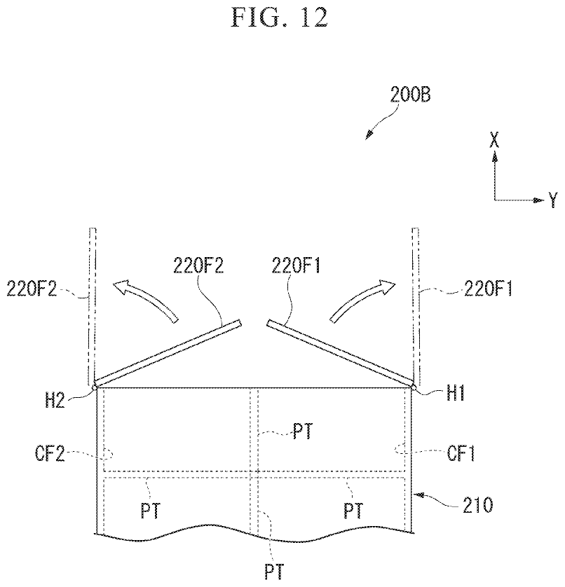

FIG. 12 is a plan view of a front end portion of the baggage transportation vehicle 200B. The two upper front doors 220F1 and 220F2 form hinged double doors. That is, the two upper front doors 220F1 and 220F2 are disposed to be adjacent to each other. An end portion of the upper front door 220F1 located on the opposite side of the upper front door 220F2 is pivotally supported by a hinge H1 (a first hinge). An end portion of the upper front door 220F2 located on the opposite side of the upper front door 220F1 is pivotally supported by a hinge H2 (a second hinge). Similarly, the two upper center doors 220C1 and 220C2 form hinged double doors. The two upper center doors 220C3 and 220C4 form hinged double doors. The two upper rear doors 220B1 and 220B2 form hinged double doors.

According to such a configuration, a part of the baggage storage part C can be used as a large room, and the convenience of the user U can be enhanced.

### Fourth Embodiment

Next, the fourth embodiment will be described. The fourth embodiment is different from the second embodiment in that a projector 235 is provided in place of the first display device 231. Configuration others than that described below are the same as the configurations of the first embodiment.

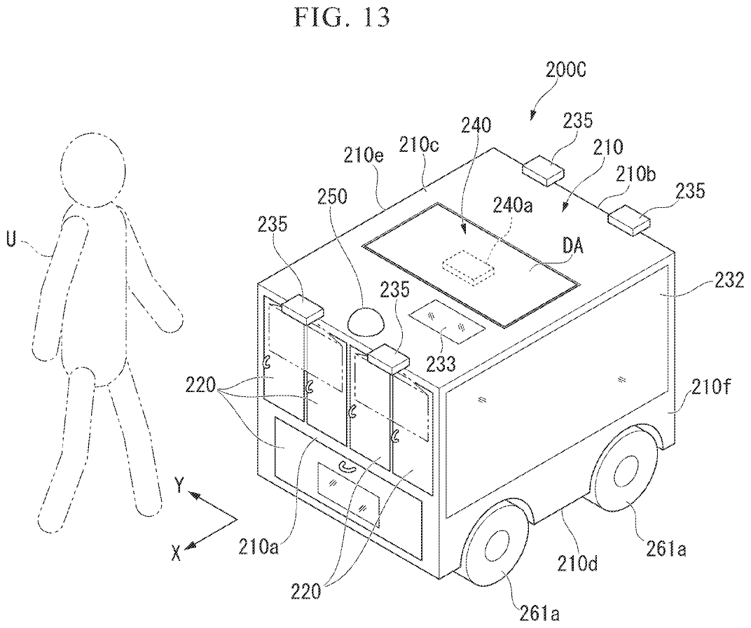

FIG. 13 is a perspective view showing a baggage transportation vehicle 200C of the fourth embodiment. In the present embodiment, the baggage transportation vehicle 200C has a projector 235 instead of the first display device 231. The projector 235 is provided at a front end portion or a rear end portion of the vehicle body 210, and can display a video or an image on the front surface 210a or the rear surface 210b of the vehicle body 210. The projector 235 is another example of a display part that displays the delivery status on the front surface 210a or the rear surface 210b of the vehicle body 210. The projector 235 displays various types of information on, for example, the front surface of the upper front doors 220F1, 220F2, 220F3 and 220F4 (that is, the surface of the door 220) or the rear surface of the upper rear doors 220B1, 220B2, 220B3 and 220B4 (that is, the surface of the door). For example, the projector 235 displays at least a part of the delivery status on the surface of the doors 220.

According to such a configuration, even when the door 220 is provided on the front surface 210a and the rear surface 210b of the vehicle body 210, the delivery status or the like can be notified to the outside. As a result, the convenience of the user U can be further enhanced.

While preferred embodiments of the invention have been described and illustrated above, it should be understood that these are exemplary examples of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

### EXPLANATION OF REFERENCES

100 Terminal device

200, 200A, 200B, 220C Baggage transportation vehicle (unmanned delivery machine)

210 Vehicle body

210a Front surface

210b Rear surface

210c Upper surface

210d Lower surface

210e Left side surface

210f Right side surface

220 Door

220F1, 220F2, 220F3, 220F4 Upper front doors

220F5 Lower front door

220B1, 220B2, 220B3, 220B4 Upper rear doors

220B5 Lower rear door

231 232, 233 Display device (display part)

P Baggage

C Baggage storage part

CF1, CF2, CF3, CF4 Upper front storage part

CF5 Lower front storage part

CB1, CB2, CF3, CB4 Upper rear storage part

CB5 Lower rear storage part

What is claimed is:

1. An unmanned delivery machine comprising:
a vehicle body;
a drive device which is configured to automatically drive the vehicle body;
a baggage storage part provided on the vehicle body; and
doors which are provided on a front surface and a rear surface of the vehicle body, are configured to allow access to the baggage storage part and are openable and closable.

2. The unmanned delivery machine according to claim 1, wherein the baggage storage part includes a front storage part and a rear storage part which are partitioned from each other, and
the doors include a front door which is provided on the front surface of the vehicle body and is configured to allow access to the front storage part and is openable and closable and a rear door which is provided on the rear surface of the vehicle body and is configured to allow access to the rear storage part and is openable and closable.

3. The unmanned delivery machine according to claim 1, further comprising:
a display part which is configured to display a delivery status on the front surface or the rear surface of the vehicle body.

4. The unmanned delivery machine according to claim 3, wherein the display part is configured to display at least a part of the delivery status on the surface of the door.

5. The unmanned delivery machine according to claim 3, wherein the display part is a projector, a liquid crystal display or an organic electroluminescence display.

6. The unmanned delivery machine according to claim 1, further comprising:
a restricting fixture which is visible from the outside when the vehicle is stopped and is configured to restrict movement of the vehicle body.

7. The unmanned delivery machine according to claim 6, wherein the restricting fixture is a brake.

8. The unmanned delivery machine according to claim 1, wherein the baggage storage part includes an upper storage part and a lower storage part which are arranged above and below each other,
the doors include an upper door which is configured to allow access to the upper storage part and is openable and closable and a lower door which is configured to allow access to the lower storage part and is openable and closable, and
the lower storage part has a slider which is movable between a first position at which it is accommodated in the lower storage part and a second position at which it protrudes from the vehicle body.

9. The unmanned delivery machine according to claim 1, further comprising:
a display part which is provided on a side surface of the vehicle body and is capable of displaying advertisements.

10. The unmanned delivery machine according to claim 1, wherein the baggage storage part includes a first storage part and a second storage part which are aligned with each other,
the doors include a first door which is configured to allow access to the first storage part and is openable and closable and a second door which is configured to allow access to the second storage part and is openable and closable,
the first door and the second door are arranged to be adjacent to each other,
an end portion of the first door on an opposite side of the second door is supported by a first hinge, and
an end portion of the second door on an opposite side of the first door is supported by a second hinge.

11. The unmanned delivery machine according to claim 10, wherein the baggage storage part has a partition between the first storage part and the second storage part, and the partition is detachable.

12. The unmanned delivery machine according to claim 10, wherein each of the first door and the second door is openable up to 90 degrees.

13. The unmanned delivery machine according to claim 1, further comprising:
a weight detection part capable of measuring a weight of baggage placed on the upper surface of the vehicle body.
